(19) United States
(12) Patent Application Publication
(10) Pub. No.: US 2006/0053989 A1
(43) Pub. Date: Mar. 16, 2006

(54) SELF-CONTAINED CASSETTE MATERIAL CUTTER AND METHOD OF CUTTING

(75) Inventors: Michael J. Weiss, East Jewett, NY (US); Sean A. Allen, Hopewell Junction, NY (US); Vladimir Jambrih, Kingston, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 10/711,373

(22) Filed: Sep. 14, 2004

(51) Int. Cl. B26D 1/00; B26D 5/00

(52) U.S. Cl. 83/13; 83/134; 83/821

(57) ABSTRACT

A modular cassette cutter design with a unique blade retention system for making multiple, simultaneous cuts in elongated strip material. The blades are retained so that they can be individually replaced. The blade hardware is made accessible from one side of the tool for easy replacement. The cassette modules lend themselves for easy accommodation to different types of gasket material and shapes. The cassette module cutters are easily interchangeable to make end cuts or corner cuts, and may be combined in a single press to make different cuts simultaneously. Prefabricated gaskets may be cut using data from linear measurements of cover designs.

### BACKGROUND OF THE INVENTION

1. Field of the Invention

The present invention relates to cutting tools, and more specifically to a cassette cutter for insertion within a cutting press. The present invention further relates to a self-contained, easily reconfigurable cutter for making elongated, non-linear cuts in material used for manufacturing gaskets and the like. The gaskets may be used for machines in semiconductor fabrication and other applications.

2. Description of Related Art

In the course of rebuilding semiconductor fabrication machinery having access covers that seal in a hydrogen atmosphere at extreme temperatures, the gaskets on the covers must be removed and the covers resealed to extend the life of the machine. Typically, each tool has up to forty covers with the perimeter of the covers ranging anywhere from five to thirty-two feet of sealing area. The material for the cover gaskets generally comes on spools of two hundred feet. In order to accommodate corners and turns in the gasket covers, multiple cuts are made in the gasket stock, with butt-ends cut by hand with a razor knife to fit each cover. Typically, a corner gasket requires multiple, accordion placed triangular wedge cuts that allow the gasket to fold without buckling. However, the hand cuts and subsequent installation leads to questionable reliability due to inconsistent accuracy and quality of the cuts. In some cases, seal failures are directly attributable to the inaccuracies in gasket cutting, specifically in the compound cuts required in the gasket for creating a corner seal or an end seal.

There remains a defined need in the art to have an accurate cutting tool capable of making accurate compound cuts for creating corners and ends for gasket-like material.

Bearing in mind the problems and deficiencies of the prior art, it is therefore an object of the present invention to provide an apparatus that is capable of making compound cuts for corners and ends in elongated material that can be linearly fed into the apparatus.

It is another object of the present invention to provide a cutting tool that is easily adaptable for different types and shapes of gasket material that can perform consistent, repeatable cuts.

A further object of the invention is to provide a cutting assembly that is modular in design with a blade retention system that allows for individual blade section replacement.

It is yet another object of the present invention to provide cutter assemblies dedicated to specific cutting that are modularly interchangeable with each other.

Still other objects and advantages of the invention will in part be obvious and will in part be apparent from the specification.

### SUMMARY OF THE INVENTION

The above and other objects, which will be apparent to those skilled in art, are achieved in the present invention, which is directed to in a first aspect, an apparatus for making a cut in an elongated strip of material comprising: at least one modular, self-contained cassette cutter including: an upper cutter portion having a blade retaining plate and at least one blade, the upper cutter portion in slideably movable contact with a lower cutter portion; retaining springs acting on and separating the cutter portions; and setscrews in contact with the at least one blade for pressably securing the at least one blade to the blade retaining plate; wherein the apparatus further comprises screw holes through the lower cutter portion for mounting the apparatus to a press. The apparatus further comprising an L-shaped slot within the blade retaining plate for securing the at least one blade for end cutting. The apparatus may comprise a short blade and a long blade for the end cutting. The apparatus may also comprise at least two flat tipped setscrews for press fitting a long portion of the at least one blade, and a tapered tipped setscrew for press fitting a short portion of the at least one blade. One blade may be a separate long blade, and the short portion of the at least one blade may be a separate short blade. The apparatus may also include a plurality of triangular shaped slots within the blade retaining plate for securing the at least one blade for corner cutting. A plurality of straight blades may be arranged in a saw-tooth fashion to cut the plurality of triangular shaped slots in the elongated strips of material for corner cutting.

In a second aspect, the present invention is directed to a self-contained cassette module cutter for cutting elongated strips of material in a press to form predetermined shapes comprising: an upper cutting portion including: an adapter pressure plate; at least one cutting blade; a blade retainer plate comprising: a plurality of slots for holding the at least one cutting blade, the plurality of slots geometrically positioned such that the at least one cutting blade forms an L-shape for end cutting or a plurality of triangular shapes for corner cutting; screw holes positioned for mounting screws to press and secure the at least one cutting blade against the blade retainer plate; mounting screws securing the adapter pressure plate to the blade retainer plate; and a top front and top rear safety shield; a lower cutting portion including: a base plate/material cradle; a stripper plate; and a bottom front and bottom rear safety shield; guide pins passing through the blade retainer plate, return springs, return spring seats, and threaded into the base plate/material cradle; apertures at each end of the longitudinal axis of the cassette module for inserting and exiting the elongated strips of material; and cassette base mounting screws securing the lower cutter portion to a press.

In a third aspect, the present invention is directed to a method of cutting elongated strip material comprising: marking the elongated strip material with linear measurements of locations for corner cuts and end cuts; attaching at least one end cut cassette module in a press, the at least one end cut cassette module including a plurality of slots for holding at least one cutting blade, the plurality of slots geometrically positioned such that the at least one cutting blade forms an L-shape for end cutting; operating the press with the at least one end cut cassette module secured therein to perform end cuts at the linear measurements marked for end cuts on the elongated strip; and moving the elongated strip to additional linear measurements for end cuts and operating the press with the cassette module to perform additional end cuts. The method further comprises: attaching a corner cut cassette module in the press, the corner cut cassette module including a plurality of blades forming a triangular shape for corner cutting; and moving the elongated strip to linear measurements for corner cuts and operating the press with the corner cut cassette module to perform corner cuts.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a front view a cassette cutter tool of the present invention.

FIG. 2 depicts an end view of the cassette cutter of FIG. 1.

FIG. 3 is a top view of the punch plate/blade retainer plate of the end cutter embodiment of the invention.

FIG. 4 is a three-dimensional view from the top of gasket stock showing the cut made by the cassette cutter of the present invention, along with the corresponding blade arrangement.

FIG. 5 is a top view of the punch plate/blade retainer plate of an approximately 90-degree Corner Cutter embodiment of the present invention.

FIG. 6 is a 3-dimensional view of a gasket stock showing the cut made by, and blade arraignment of the approximately 90-degree corner cutter embodiment of the present invention.

FIG. 7 is a top view of the striper, cutter base plate/material cradle of a half-round end cutter embodiment of the present invention.

FIG. 8 is a 3-dimensional wire frame view of a half-round gasket cutter base plate showing the cutting blade relief and striper plate for an end cutter embodiment of the present invention.

### DESCRIPTION OF THE PREFERRED EMBODIMENT(S)

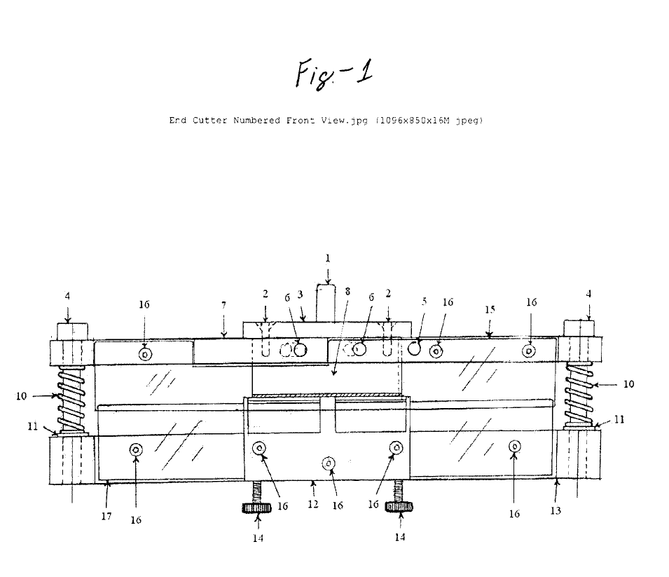

In describing the preferred embodiment of the present invention, reference will be made herein to FIGS. 1-8 of the drawings in which like numerals refer to like features of the invention.

The cassette type material cutter is a self-contained cutter assembly that can be fitted to a manual or automated press, such as an arbor press. The cassette cutter module is capable of making specific cuts and easily configurable for different types of cuts. Each cassette cutter module is developed as a single, self-contained unit containing all the necessary elements for cutting. Importantly, the cassette module cutter is designed to make multiple cuts simultaneously.

The preferred embodiment of the present invention defines a modular design for press cutting material shaped in elongated strips. A blade retention system is employed in a cassette module to retain multiple piece blade sections for making complex configuration cuts. Importantly, in the preferred design, the blade sections may be replaced individually as needed to maintain sharp cutting edges. The modular cassette design is easily adaptable to different types of gasket material and various gasket shapes to fit different cover designs. The cassette units are easily interchangeable, which provides for immediate flexibility during manufacturing.

In an automated application a number of cassettes may be arranged on the material path in order to make the different cuts needed to complete a gasket. Each cassette cutter is designed and manufactured to make one compound cut, which comprises multiple cuts in a single action. A series of cuts may be made in the material to form the gasket strip in any shape needed. Typically, the type material intended for use in the cutter is soft pliable material, available in coils or on reels, such as silicon, or the like.

A cassette base plate/material cradle may be formed to support any cross sectional shape material. For example, in one embodiment the cassette cradle is flat, while in a second embodiment the cassette cradle has a semi-circular cross section to accommodate round or semi-round strips. The cradle may also be heated or cooled to aid in material workability. Each cutter has inexpensive multiple piece blades sections held in place in a geometry that makes them capable of making complex angled cuts. For an end cut, two blades are used as further described herein. For a corner cut, a number of triangularly placed blades are used to cut notches in the material, making the material capable of bending around corners. The blade sections can be replaced individually, as needed. However, the design is also capable of accommodating one-piece blades, and is not limited to the number of blades needed to make a compound cut. The blade retention system is simply constructed, as compared to other prior art systems, and all blade-retaining hardware is made accessible from one side of the tool for easy access and removal. Because of the preferred mechanical design, the cutter assembly is easy to service, requiring only three Allen wrenches to completely disassemble, assemble, or service any part of the tool. The cutter design is scalable to any size material and is easily adaptable to different types and/or shapes of material. Each cut and cutter is designed using the centerline of the gasket material and cut as reference points. So each cutter can be used for making inside or outside cuts from predetermined linear measurements stored in a database. Moreover, each cutter is fabricated with identical mounting points allowing for quick interchangeability of the units. The preferred design allows quick set up and use either automated or by hand.

FIG. 1 shows a front view of one embodiment of the cassette cutter tool of the present invention. This cassette module is used for an end cut in a gasket, and is referred to as an end cutter. Preferably, two blades are used to make the end cut, a long blade 8 and a short blade 9, although the arrangement can easily accommodate a single L-shaped blade. The top portion of the cassette cutter includes an adapter pressure plate 3 mounted using an adapter pressure plate mounting pin 1 and mounting screws 2. Preferably, four mounting screws are used to mount the adapter pressure plate 3, although any number and geometric placement that provides uniform force may be used. Mounting pin 1 is used to attach the blade retainer plate 7 to the ram of the press through the adapter pressure plate 3. The mounting pin 1 is press fit into the adapter pressure plate 3, which in turn is screwed to the punch plate/blade retainer plate 7. All three of these parts may be machined from a hard material, such as A6 tool steel, and the like. The adapter pressure plate 3 also acts as a backstop for the cutting blades. The force from the press is transferred from the ram to the blades. The adapter pressure plate 3 is secured to the punch plate/blade retainer plate 7, as are the top safety shields 15, 19. The upper safety shields are attached using shield-mounting screws. Nine front shield-mounting screws and an equal number in the rear are employed in the preferred design for both the top and bottom portions of the cassette design, although the design may accommodate different amounts of mounting screws depending upon the length and width of the cassette, as long as a sufficient number is used to effectively secure the shield. Guide pins 4 attach the top portion of the cassette cutter to the bottom portion. Preferably, the guide pins are located on each corner of the cassette; although other locations may be arranged provided a necessary uniform force can be maintained during cutting. The guide pins 4 hold return springs 10 that work to lift the top portion after each cut. The return springs 10 are situated in spring seats 11, which hold the springs in place and protect the cutter base cradle. The guide pins 4 pass through the punch plate/blade retainer plate 7, the return springs 10, and the return spring seats 11, and thread into the cutter base plate/material cradle 13. The cutter base plate/material cradle 13 is preferably made of DELRIN® high strength plastic, or the like. The holes that the guide pins 4 and two cassette base mounting screws 14 thread into are helicoiled. The cassette base mounting screws 14 are used to mount the lower assembly to the press frame so that the only movement is the press pushing the upper assembly down and pulling it back up while staying aligned with and parallel to the lower assembly. The lower or bottom cutter portion includes the cutter base plate or material cradle 13, bottom safety shields 17, 20, and two cassette base mounting screws 14. The stripper 12 is also mounted to the bottom cutter portion using some of the lower safety shield mounting screws.

As noted above, the cassette cutter may simultaneously retain separate blades. Shown in the front view of FIG. 1 is a long cutting blade 8. The blade cuts longitudinally at an angle into the material strip, which forms part of the end cut. This blade is retained by setscrews 6. Preferable, two setscrews are used for the long cutting blade.

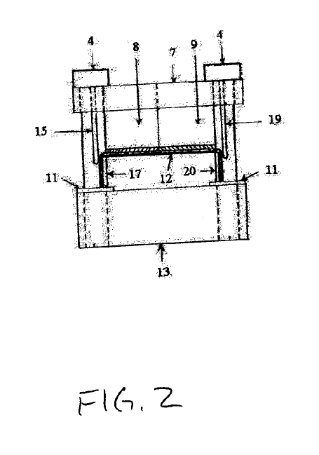

FIG. 2 depicts an end view of the cassette end cutter of FIG. 1. This view depicts the detail of the top front safety shield 15, top rear safety shield 19, bottom front safety shield 17, bottom rear safety shield 20, and the striper 12. The short cutting blade 9 is visible from this view. The short cutting blade 9 completes the end cut, cutting lateral to the longitudinal cut of the long blade, preferable at approximately 95-degrees from the long blade cut, although other angles are certainly possible and not prohibited by the design. The bottom safety shields act as material guides.

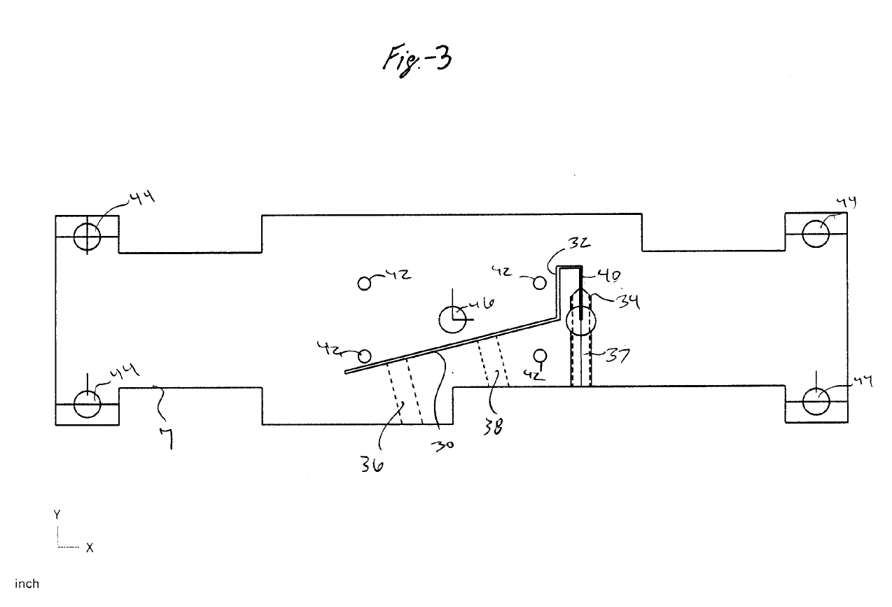

FIG. 3 is a top view of the punch plate/blade retainer plate 7 for the end cutter cassette module. The cutting blades are held in slots 30, 32. Slot 30 secures the long cutting blade 8, and slot 32 secures the short cutting blade 9. The slots tightly secure the blades via a close tolerance fit and setscrews 5 and 6. A taper tipped setscrew 5 when tightened into screw hole 37 presses flexing wedge 40 against the short cutting blade 9 securing it in slot 32. The blade retention for the long cutting blade 8 uses two setscrews 6 which both have the tips ground flat. The long blade setscrews 6 both mount the blade from the front of the punch plate/blade retainer plate 7 through screw holes 36, 38 at an angle perpendicular to the long cutting blade's surface. The short cutting blade setscrew 5 also enters from the front of the punch plate/blade retainer plate 7 through screw hole 37. Four holes 42 are also shown for placement of the four adapter plate mounting screws. The gasket strip is fed in the direction of the blade retainer plate long axis.

Preferably, the cutting blades are made of a hard material such as blue spring steel or the like. At the corner where the long cutting blade 8 and the short cutting blade 9 meet, the edges that touch are ground to form an exact angle in a miter-cut fashion. The close tolerances are preferable to hold the blades in place and keep the tips of the cutting edges lined up so that the combination acted as one single blade for accurate cuts. At the far corners, holes 44 for the guide pins are shown. Centrally, the mounting position 46 is shown for the adapter pressure plate mounting pin 1, along with the four retaining screw holes 42 for mounting screws 2 that secure the adapter pressure plate to the punch plate/blade retainer plate 7.

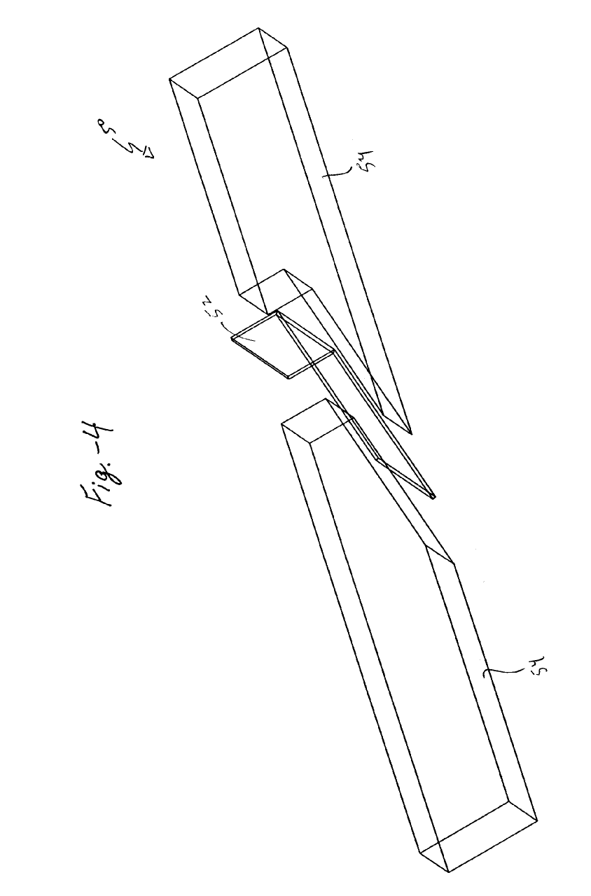

FIG. 4 is a three-dimensional view from the top of gasket stock 50 showing the cut made by the cassette end cutter of the present invention, along with the corresponding blade arrangement 52. The gasket stock shown is 1 inch by ½ inch stock; however, other stock sizes may be accommodated by the design with modification to the blades' dimensions. As shown, the blade configuration yields a tapered cut, which acts as a chevron seal under pressure to make a leak proof bond. The bottom portion of the gasket 54 represents the inside cover portion of the gasket when the gasket seal is under positive pressure. In the case of negative pressure, the arrangement of the gasket ends would be reversed from the position shown here.

The assembly guide pins 4 hold the cassette both together and in alignment. The punch plate/blade retainer plate 7 moves vertically over the pins while staying parallel to the cutter base plate/material cradle 13. The return springs 10 keep the unit open when not in use, thus keeping the upper and lower assemblies parallel and ready for the next material insertion.

The top front safety shield 15 and the top rear safety shield 19 are secured to the punch plate/blade retainer plate 7 with the shield mounting screws 16. The safety shields are preferably made of clear LEXAN®, or the like, to allow visibility while preventing inadvertent user contact. The cassette module is designed to have sufficient length before and after the blade so that with the front and rear safety covers in place, a person's hand would not easily contact the blade through the material path.

In the preferred embodiment, the bottom front safety shield/material guide 17 and the bottom rear safety shield/material guide 20 are screwed to the cutter base plate/material cradle 13 at each end with shield mounting screws 16. The striper 12 is then positioned over both bottom shields 17, 20 and the cutter base plate/material cradle 13 and three mounting screws 16, front and back, are installed through both. The top shields 15, 19 traverse down over the lower shields 17, 20 and the striper 12. The striper 12 is preferable made of a hard material, such as tool steel or the like, and is made to fit over the cutter base plate/material cradle 13. In this embodiment, it also fits over both lower shields 17, 20. The striper 12 has a close tolerance slot cut in it to match the cutting edge of the blades. There may also be windows cut out of the front surface. When used in a manual press these windows are used to view the alignment of the material for cut placement. With the cassette module expanded, blades 8, 9 pull up just out of the striper 12. FIG. 2 shows the relationship of the punch plate/blade retainer plate 7, long cutting blade 8, short cutting blade 9, top shields 15, 19, lower shields 17, 20, striper 12, and the cutter base plate/material cradle 13.

With the adapter pressure plate mounting pin fixed to the press ram and the cutter base plate/material cradle 13 mounted to the press frame using the cassette base mounting screws 14, the tool is ready for making an end cut. Material is passed through the cassette to the point where the cut is desired. When the press is activated, blades 8, 9 pass through the striper 12, cut through the material when the sharp edge blade bottom comes in contact with the cutter base plate/material cradle 13, and stop. Reversing the press pulls the blades up out of the material through the striper, which holds the material down and in shape, allowing full blade extraction. The material is then linearly moved along the longitudinal axis of the cassette module to the next cut location, and the cutting process is repeated.

The cassette cutters are modular and capable of mounting in a small, manual Arbor press. To facilitate the cutting process, measurements may be taken to develop a linear relationship for each cover gasket, and the measurement data stored. The linear measurements take into account each corner that the gasket must turn, and each end where the gasket is to terminate. With these linear measurements, the gasket stock is laid out and the location of the cuts marked on it. A cutter module is mounted within the press and the material is fed into it until each locating mark lines up within in the alignment window. The press is operated and the material is cut and removed. Typically an end cutter module is mounted first for an end cut, followed by the corner cutter module. After the end cut, the corner cutter module is inserted and the first corner location is located and cut. The material is advanced to subsequent corner locations, each of which are aligned and then cut. The material is then removed from the corner cutter, and the end cutter reinstalled in the press. The material is fed back through the end cutter in the same way relative to the first end cut until the second end cut location mark is aligned. After the press is operated and the gasket cutting is complete, the gasket can be labeled and stored. For multiple gaskets, the material may be laid out with all cutting locations marked for corner and end cuts initially before cutting, and labeled as to which cover each gasket belongs. In this manner, once the cutting process commences, the second end cut assembly for the first gasket would become the first end cut assembly for the next gasket. Thus, it is feasible to mount the corner cutter cassette module in the press and make all corner cuts first in a multiple gasket run, and then mount the end cutter cassette module to make all end cuts. In this way, the cassette module interchangeability promotes efficiency during manufacture.

Although the cutting process is described herein for a manual feed and manual replacement of the cassette modules, one may automate the process by mounting a number of cutters in line with a power feed system.

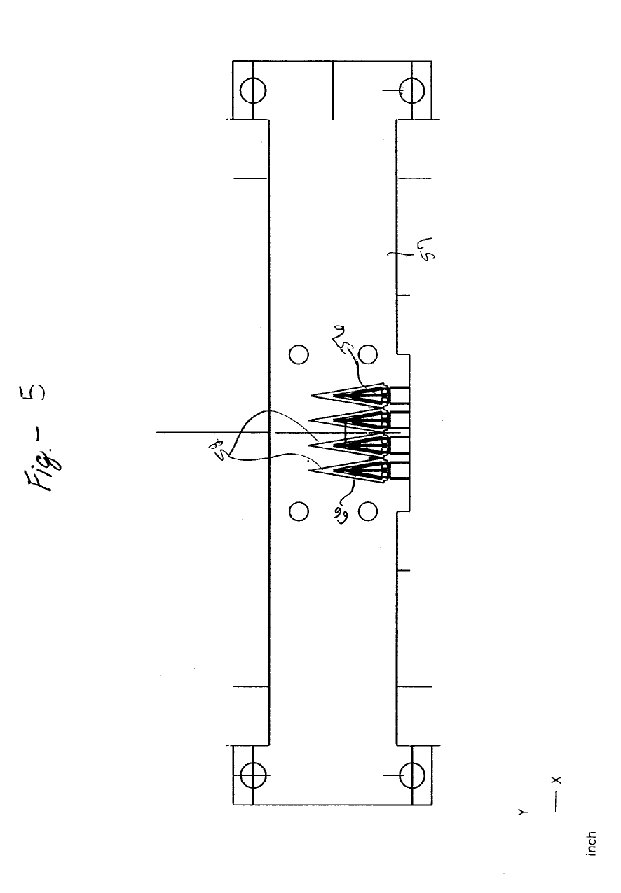

FIG. 5 is a top view of a punch plate/blade retainer plate 57 for an approximate 95-degree corner cutter embodiment of the present invention. Multiple triangular cuts 58 are made with this single blade retainer plate. In each triangular slot 58, blade segments 66 are wedged under force against the plate. The forcing action is provided by tightening tapered tipped setscrews 53 pressing flexing wedge holders 56 into the triangular slots. Once enough multiple triangular cuts are made in the gasket stock, it is capable of bending at the predetermined angle without buckling, while maintaining more uniform rigidity or hardness of the material. The triangular slots may be modified such that an angle other than 90-degrees is formed when the triangular notches are made. Thus, the corner cassette module is capable of cutting gaskets for cover designs that have other than 90-degree turning points, for example an octagonal cover.

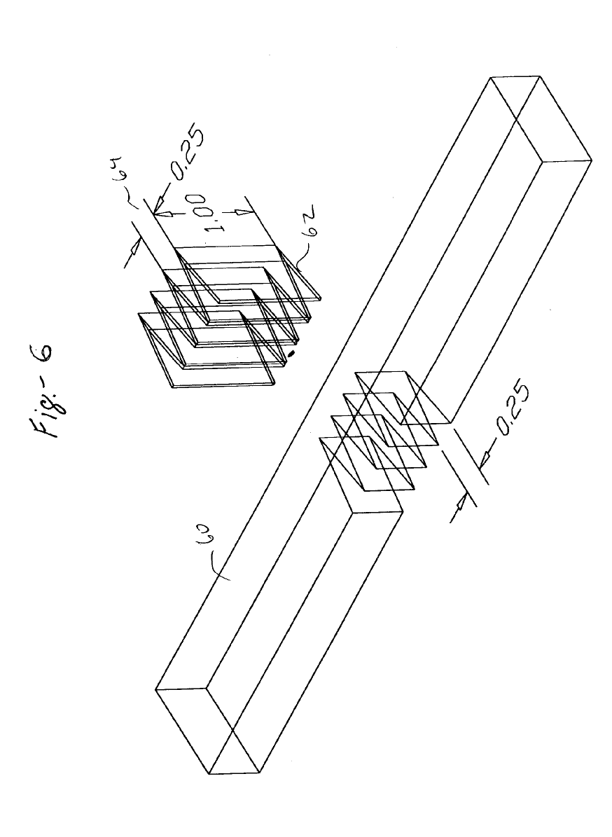

FIG. 6 is a 3-dimensional view of a gasket stock 60 showing the cut made by, and blade arraignment 62 of, the corner cutter embodiment of the present invention. Although many different blade arrangements are feasible in the present invention, preferably for a 90-degree cut, or approximate right angle cut, the blades form a series of triangular shapes that are approximately 0.25 inches from point-to-point 64 and approximately 1 inch in height for ½″ thick gasket stock, although other heights are easily adaptable to the cassette module design, provided that the blade height is adjusted accordingly.

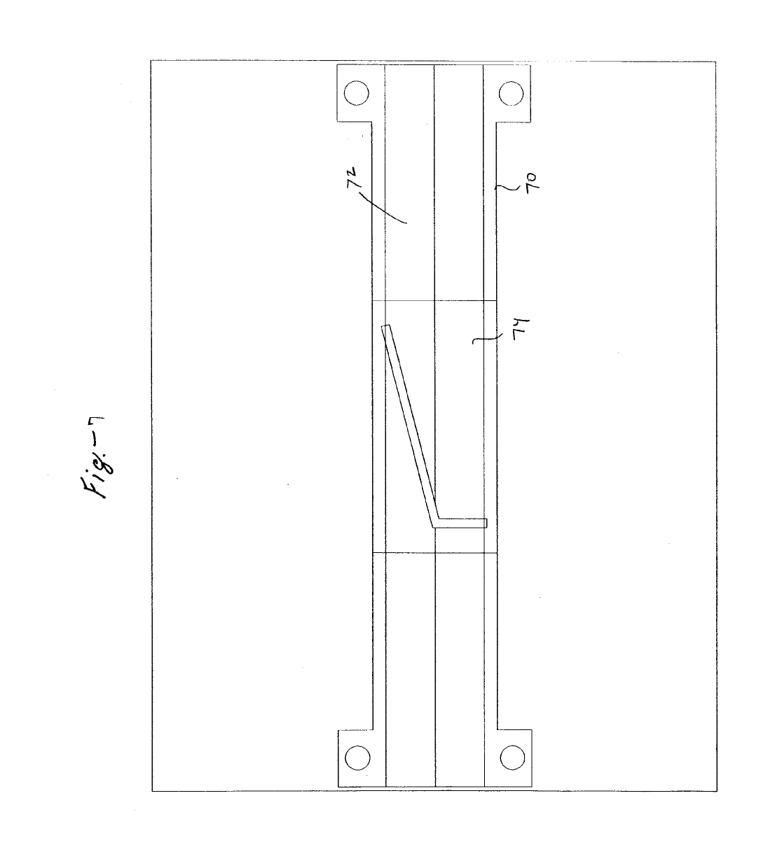

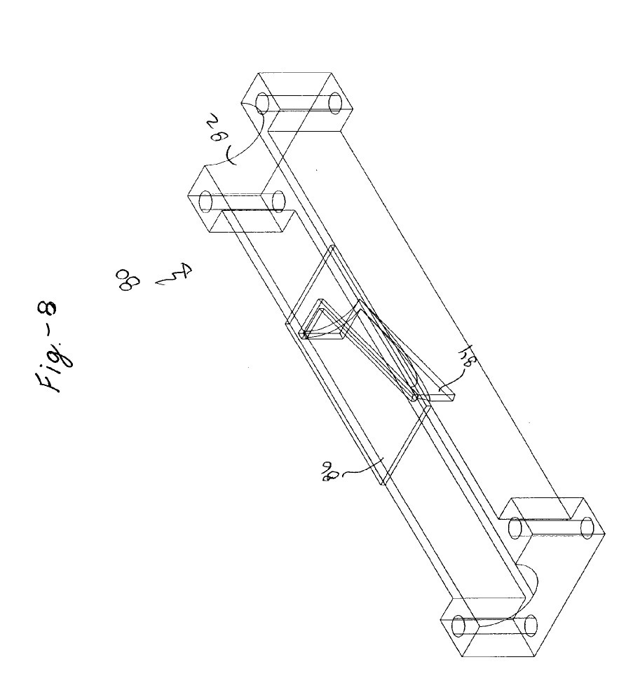

For gaskets that are rounded or partially rounded, the cutter base plate/material cradle may be shaped to accommodate the curvature. FIG. 7 is a top view of the striper 74 and cutter base plate/material cradle 72 of a half-round end cutter embodiment 70 of the present invention. FIG. 8 is a 3-deminsional wire frame view 80 of the half-round gasket cutter base plate 82 showing the cutting blade relief 84 and striper plate 86 for an end cutter embodiment.

As described above, the present invention provides for a modular cassette cutter design with a unique blade retention system to make multiple, simultaneous cuts in elongated strip material. The blades are retained such that they can be individually replaced as needed. The blade hardware is made accessible from one side of the tool for easy replacement. The cassette modules lend themselves for easy accommodation to different types of gasket material and shapes. The cassette module cutters are easily interchangeable to make end cuts or corner cuts. The present invention allows for prefabricated gaskets to be made from databases of linear measurements of cover designs.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

What is claimed is:

1. An apparatus for making a cut in an elongated strip of material comprising:
at least one modular, self-contained cassette cutter including:
an upper cutter portion having a blade retaining plate and at least one blade, said upper cutter portion in slideably movable contact with a lower cutter portion;
retaining springs acting on and separating said cutter portions; and
mounting pins in contact with said at least one blade for pressably securing said at least one blade to said blade retaining plate;
wherein said apparatus further comprises screw holes through said lower cutter portion for mounting said apparatus to a press.

2. The apparatus of claim 1 further comprising an L-shaped slot within said blade retaining plate for securing said at least one blade for end cutting.

3. The apparatus of claim 2 further comprising a short blade and a long blade for said end cutting.

4. The apparatus of claim 2 including screw holes in said blade retaining plate for tapered tipped setscrews to press fit said at least one blade against said blade retaining plate.

5. The apparatus of claim 4 further comprising at least two flat tipped mounting pins for press fitting a long portion of said at least one blade, and tapered tipped setscrews for press fitting a short portion of said at least one blade.

6. The apparatus of claim 5 wherein said long portion of said at least one blade is a long blade, and said short portion of said at least one blade is a short blade.

7. The apparatus of claim 1 including a plurality of triangular shaped slots within said blade retaining plate for securing said at least one blade for corner cutting.

8. The apparatus of claim 7 further including a plurality of straight blades arranged in a saw-tooth fashion to cut said plurality of triangular shaped slots in said elongated strips of material for corner cutting.

9. The apparatus of claim 8 further comprising a triangular shaped wedge for pressing two of said straight blades against said blade retainer plate, such that said straight blades form two adjacent sides of a triangle.

10. The apparatus of claim 1 further including mounting screws for attaching said apparatus to an arbor press.

11. A self-contained cassette module cutter for cutting elongated strips of material in a press to form predetermined shapes comprising:
an upper cutting portion including:
an adapter pressure plate;
at least one cutting blade;
a blade retainer plate comprising:
a plurality of slots for holding said at least one cutting blade, said plurality of slots geometrically positioned such that said at least one cutting blade forms an L-shape for end cutting or a plurality of triangular shapes for corner cutting;
screw holes positioned for setscrews to press and secure said at least one cutting blade against said blade retainer plate;
mounting screws securing said adapter pressure plate to said blade retainer plate; and
a top front and top rear safety shield;
a lower cutting portion including:
a base plate/material cradle;
a stripper plate; and
a bottom front and bottom rear safety shield;
guide pins passing through said blade retainer plate, return springs, return spring seats, and threaded into said base plate/material cradle;
apertures at each end of the longitudinal axis of said cassette module for inserting and exiting said elongated strips of material; and
cassette base mounting screws securing said lower cutter portion to a press.

12. The self-contained cassette module cutter of claim 11 further comprising a short blade and a long blade for said end cutting.

13. The self-contained cassette module cutter of claim 12 further comprising flat tipped screws accessible from a first side of said cassette module and positioned by a portion of said plurality of slots for pressing said long blade against said blade retainer plate.

14. The self-contained cassette module cutter of claim 12 further comprising a screw hole having a tapered end for a tapered tipped setscrew to press fit said short blade against said blade retainer plate, said tapered tipped setscrew accessible from a first side of said cassette module.

15. The self-contained cassette module cutter of claim 14 wherein said tapered tipped setscrew presses against a wedge in contact with said short blade.

16. The self-contained cassette module cutter of claim 15 wherein said tapered tipped setscrew is aligned approximately parallel to said short blade direction.

17. The self-contained cassette module cutter of claim 11 further comprising a plurality of straight blades arranged in a saw-tooth fashion to cut a plurality of triangular slots in said elongated strips of material for corner cutting.

18. The self-contained cassette module cutter of claim 17 further comprising a triangular shaped flexing wedge for pressing two of said straight blades against said blade retainer plate, such that said straight blades form two adjacent sides of a triangle.

19. A method of cutting elongated strip material comprising:
marking said elongated strip material with linear measurements of locations for corner cuts and end cuts;
attaching at least one end cut cassette module in a press, said at least one end cut cassette module including a plurality of slots for holding at least one cutting blade, said plurality of slots geometrically positioned such that said at least one cutting blade forms an L-shape for end cutting;
operating said press with said at least one end cut cassette module secured therein to perform end cuts at said linear measurements marked for end cuts on said elongated strip; and
moving said elongated strip to additional linear measurements for end cuts and operating said press with said cassette module to perform additional end cuts.

20. The method of cutting of claim 19 further comprising:
attaching a corner cut cassette module in said press, said corner cut cassette module including a plurality of blades forming a triangular shape for corner cutting; and
moving said elongated strip to linear measurements for corner cuts and operating said press with said corner cut cassette module to perform corner cuts.
